(19) United States
(12) Patent Application Publication
(10) Pub. No.: US 2012/0140071 A1
(43) Pub. Date: Jun. 7, 2012

(54) VIBRATION CANCELLATION FOR VEHICLE-BORNE GIMBAL-MOUNTED SENSOR

(75) Inventor: Neil Judell, Cambridge, MA (US)

(73) Assignee: OPTICAL ALCHEMY, INC., Nashua, NH (US)

(21) Appl. No.: 12/961,057

(22) Filed: Dec. 6, 2010

(51) Int. Cl. H04N 7/18

(52) U.S. Cl. 348/144; 348/E07.085

(57) ABSTRACT

Motion control circuitry for a vehicle-borne, gimbal-mounted sensor (such as a camera on a helicopter) includes main position control circuitry generating a commanded drive signal representing a desired driving of a positioning element (e.g. azimuth or elevation motor) to achieve a position of the sensor, and feed-forward vibration cancellation circuitry generating a cancellation drive signal representing a driving of the positioning element to cancel vehicle vibration. The feed-forward vibration cancellation circuitry includes a vibration sensor and adaptive feed-forward control circuitry, the vibration sensor generating a vibration signal representative of the vehicle vibration, and the adaptive feed-forward control circuitry applying a feed-forward gain to the vibration signal to generate the cancellation drive signal. The feed-forward gain is continually calculated as an integrating function of the vibration signal and an error signal corresponding to a mechanical response of the positioning element to the vehicle vibration. Combining circuitry (e.g., an adder) combines the commanded drive signal and cancellation drive signal to generate a combined drive signal controlling the driving of the positioning element.

### BACKGROUND

The present invention is related to the field of vehicle-borne, gimbal-mounted sensors, such as cameras or other imaging sensors carried by a helicopter.

There are many applications for gimbal-mounted sensors carried in vehicles. Gimbal-mounted sensors enable the collection of image or other data from an operating environment of the vehicle as the vehicle is moving. In one common application, a gimbal-mounted camera is attached to the underside of a helicopter and used in operation to acquire images from terrain over which the helicopter flies. The gimbal mounting enables the sensor to be pointed in a desired direction (i.e., at an object being tracked) independently of the motion of the vehicle. Sophisticated navigation and motion-control circuits are employed to effect position control of the gimbal in such applications.

It is common in these applications that the quality of the image or other data acquired by gimbal-mounted sensor(s) is affected by mechanical vibration of the vehicle, this vibration being mechanically coupled to the sensor(s) and inducing corresponding noise in the data acquired by the sensor(s). Various techniques have been employed to reduce the effect of vehicle vibration. In some systems, sophisticated mechanical isolation mechanisms may be used, while in others the circuitry used for normal motion control of the sensor(s) may be relied upon to also counteract vibration.

### SUMMARY

Known techniques for reducing the effects of vehicle vibration on the quality of images or other data obtained from gimbal-mounted sensor(s) may have limited effectiveness or other undesirable drawbacks. Mechanical mechanisms can be expensive and complex, and may not achieve a desired degree of vibration cancellation. They also generally add weight and consume valuable space, both undesirable in airborne applications in particular. Use of the normal motion control circuitry can also be limited, because such circuitry is typically designed with a “feedback” architecture that reacts to vibration of the sensor(s) rather than proactively avoiding it in the first place.

A technique is disclosed for vibration cancellation in vehicle-borne gimbal-mounted sensors that can provide a desirably high degree of vibration cancellation and thereby improve the quality of images or other data obtain from the sensors.

Motion control circuitry for a vehicle-borne, gimbal-mounted sensor (such as a camera on a helicopter) includes main position control circuitry generating a commanded drive signal representing a desired driving of a positioning element (e.g. azimuth or elevation motor) to achieve a position of the sensor, and feed-forward vibration cancellation circuitry generating a cancellation drive signal representing a driving of the positioning element to cancel vehicle vibration. The feed-forward vibration cancellation circuitry includes a vibration sensor and adaptive feed-forward control circuitry. The vibration sensor generates a vibration signal representative of the vehicle vibration, and the adaptive feed-forward control circuitry applies an adaptive feed-forward gain to the vibration signal to generate the cancellation drive signal. The feed-forward gain is continually calculated as an integrating function of the vibration signal and an error signal corresponding to a mechanical response of the positioning element to the vehicle vibration. Combining circuitry (e.g., an adder) combines the commanded drive signal and cancellation drive signal to generate a combined drive signal controlling the driving of the positioning element. In one embodiment, the circuitry is used to cancel vibration caused by the main rotor in a helicopter, and various specifics are disclosed for this application.

The use of adaptive feed-forward control circuitry enables vibration cancellation to be based on detection of vibration at its source, along with a model for how the vibration can affect the sensor, and thus can produce better results than systems which attempt to cancel vibration based on detecting it at the sensor or sensor positioning element.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a quasi-mechanical diagram showing a turret mounted to a schematically represented vehicle body;

FIG. 2 is a block diagram of motion control circuitry;

FIG. 3 is a block diagram of a motion control system according to a first embodiment;

FIG. 4 is a schematic diagram of adaptive feed-forward control circuitry;

FIG. 5 is a block diagram of a vibration sensor circuit;

FIG. 6 is a block diagram of a motion control system according to a second embodiment; and

FIG. 7 is a schematic diagram depicting alternative adaptive feed-forward control circuitry.

### DETAILED DESCRIPTION

FIG. 1 is a schematic depiction of a vehicle carrying a gimbal-mounted sensor such as an imaging camera. A turret 10 is rigidly attached to a vehicle body 12. The turret 10 includes a shell 14 and an azimuth motor 16. Within the shell 14 is mounted an “optical bench” (BENCH) 18, which is mounted to the shell 14 by an elevation motor 20 at one end and a bearing 22 at the other.

In the case of a helicopter or other aerial vehicle, the turret 10 is commonly attached to the underside of the helicopter body 12 for purposes of capturing images or other information from terrain over which the aerial vehicle is flown. For example, the turret 10 may be used to identify and track ground targets in a tactical warfare application. In operation, the sensor(s) located on the optical bench 18 are to be pointed in a desired direction (azimuthal and elevational), which is done by applying electrical drive signals to the azimuth motor 16 and elevation motor 20. The electrical drive signals are controlled by motion control circuitry (not shown in FIG. 1) which generally receives higher-level position command signals from an operator or tracking/navigation system within the vehicle.

As noted above, mechanical vibration occurring in the vehicle may be transmitted to the optical bench 18 and interfere with the quality of the images or other data that is acquired. In the case of a helicopter, one significant source of vibration is rotation of the main rotor in flight. As described in some detail below, feed-forward vibration cancellation circuitry is employed to reduce the effect of such mechanical vibration.

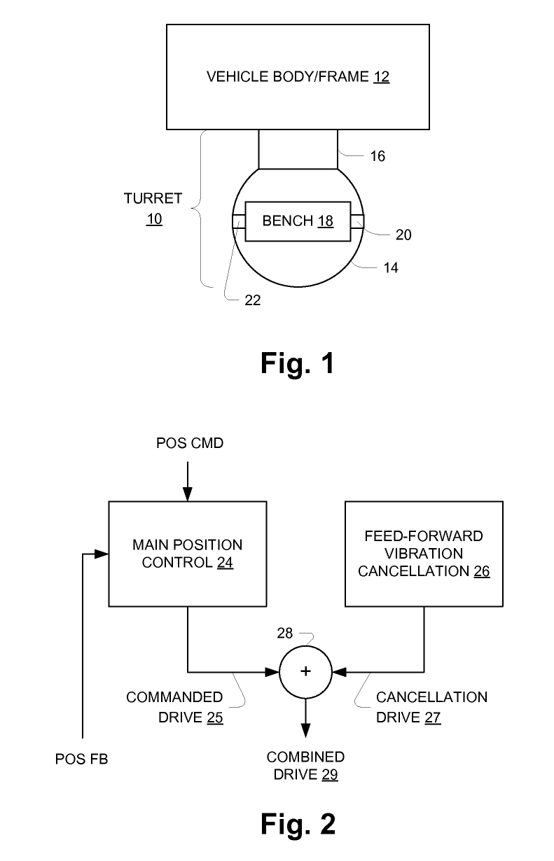

FIG. 2 is a general block diagram of motion control circuitry that may be used to control the positioning of the sensor(s) within the turret 10. It should be noted that this circuitry may be contained in the turret 10 or elsewhere in the vehicle (outside the turret 10) in different applications. The motion control circuitry includes main position control circuitry 24 and feed-forward vibration cancellation circuitry 26. The main position control circuitry 24 generates a commanded drive signal (COMMANDED DRIVE) 25 representing a desired driving of a positioning element of the turret 10 (such as the azimuth motor 16 or elevation motor 20) to achieve a desired positioning of the optical bench 18 and the sensor(s) thereon. The commanded drive signal 25 is generated in response to a higher-level position command signal (POS CMD) as well as a position feedback signal (POS FB). The higher-level position command signal represents a desired position of the sensor(s) from an operator or other higher-level controller, and the position feedback signal represents a sensed actual position of the sensor. The main position control circuitry 24 may be realized in any of a variety of ways. Two examples are provided below.

The feed-forward vibration cancellation circuitry 26 generates a cancellation drive signal (CANCELLATION DRIVE) 27 representing a desired driving of the positioning element to cancel the vehicle vibration being mechanically transmitted to the sensor(s) in the turret 10. As described in more detail below, the feed-forward vibration cancellation circuitry 26 includes a vibration sensor and adaptive feed-forward control circuitry (not shown in FIG. 2). The vibration sensor is responsive to the vehicle vibration to generate a corresponding vibration reference signal, and the adaptive feed-forward control circuitry applies an adaptive feed-forward gain to the vibration signal to generate the cancellation drive signal 27. As also described below, the feed-forward gain is continually calculated as an integrating function of the vibration reference signal and an error signal which includes an estimate of a mechanical response of the positioning element to the vehicle vibration.

The motion control circuitry of FIG. 2 also includes combining circuitry 28 (shown as an adder or summer in FIG. 2) which combines the commanded drive signal 25 and cancellation drive signal 27 to generate a combined drive signal (COMBINED DRIVE) 29 which is used to control the driving of the positioning element (e.g. azimuth motor 16 or elevation motor 20) for the sensor(s) in the turret 10. For example, COMBINED DRIVE may be a digital output sent to a pulse-width modulator (PWM) amplifier used to control driving current supplied to the positioning element. COMBINED DRIVE may be proportional to the torque exerted by the motor 16 or 20 that it drives. Note that COMBINED DRIVE may be conveyed to the motor PWM circuitry in a variety of ways, e.g., via an RS-232 link or an Ethernet link. It is also possible to use voltage drive to the motors, via digital communication or a digital-to-analog converter. Because the combined drive signal 29 includes components from both the commanded drive signal 25 and cancellation drive signal 27, it can effect desired positioning of the sensor while also inducing a counter-vibration that acts against the vehicle vibration transmitted to the positioning element, reducing the vibration at the sensor and enabling the capture of correspondingly higher quality images/data by the sensor(s).

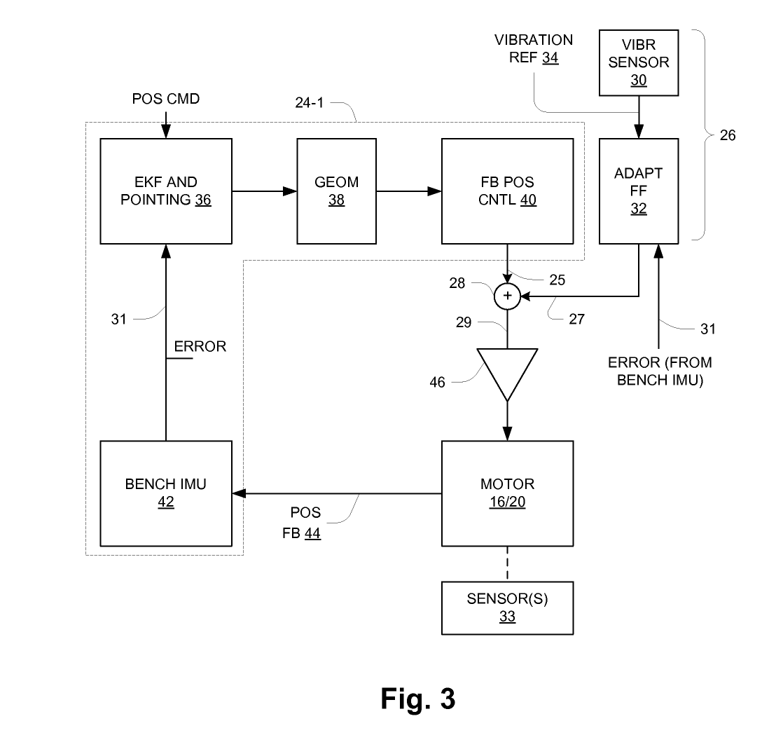

FIG. 3 shows an overall block diagram of a motion control system for a gimbal-mounted sensor. In FIG. 3 an individual motor subject to control is labeled as motor 16/20, indicating that the vibration cancellation technique may be applied to either or both the azimuth motor 16 and/or elevation motor 20 in the illustrated embodiment. Those skilled in the art will realize that the control of multiple motors will entail duplication of appropriate elements of FIG. 3 for different motors. The remaining description is provided for the control of a single motor, referred to as “motor 16/20”.

The feed-forward vibration cancellation circuitry 26, motor 16/20, and combining circuitry 28 are shown at right. The feed-forward vibration cancellation circuitry 26 includes a vibration sensor (VIBR SENSOR) 30 and adaptive feed-forward control circuitry (ADAPT FF) 32, with the vibration sensor 30 generating a vibration reference signal (VIBRATION REF) 34. The main position control circuitry 24-1 includes an extended Kalman filter (EKF) and pointing circuit 36, geometry mapping circuit (GEOM) 38, feedback position controller (FB POS CNTL) 40, and a bench inertial measurement unit (BENCH IMU) 42 which is located on the optical bench 18. The motor 16/20, which positions the sensor(s) 33, generates a position feedback (POS FB) signal 44 which is provided to the bench IMU 42. The motion control system further includes an amplifier 46 which provides drive to the motor 16/20 corresponding to the output of the combining circuitry 28.

Primary control of the position of the motor 16/20 begins with the position command signal POS CMD as discussed above. This signal is provided to the EKF and pointing circuit 36, which generates signals representing a desired positional attitude or orientation of the optical bench 18. The geometry mapping circuit 38 translates these signals into desired angles of the motor 16/20, and the feedback position controller 40 generates the commanded drive signal 25 to drive the motor 16/20 (via summer 28 and amplifier 46) to a corresponding rotational position. The actual motor position as identified by the position feedback signal 44 is used by the bench IMU 42 to generate an error signal ERROR 31, which is used by the EKF and pointing circuit 36 to update its estimate of motor position.

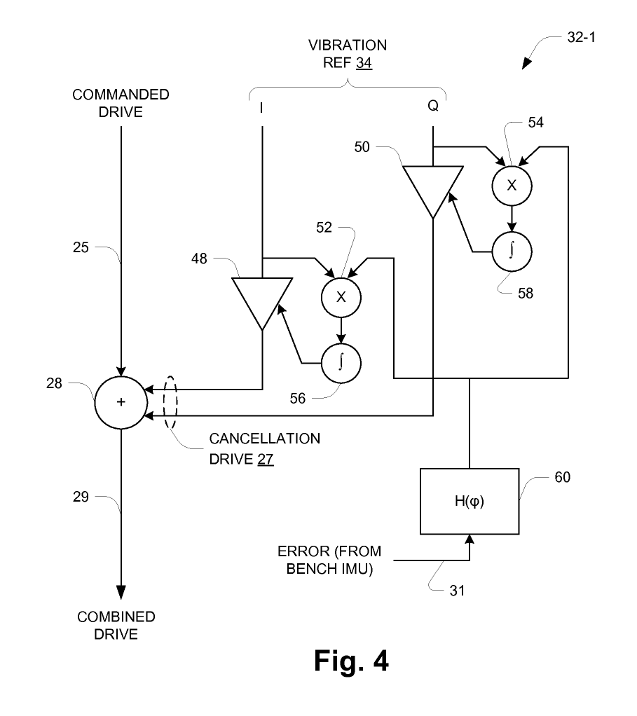

Additional control for vibration cancellation is provided by the adaptive feed-forward control circuitry 32, which uses the vibration reference signal 34 and the error signal 31 from the bench IMU 42 to generate the cancellation drive signal 27 that is supplied to the summer 28. More details about the adaptive feed-forward control circuitry 32 are provided below. FIG. 4 illustrates an embodiment 32-1 of the adaptive feed-forward control circuitry 32. The vibration reference signal 34 includes two sub-signals which are labeled in-phase (I) and quadrature (Q) signals. These signals are sinusoidal at the rotational frequency of the helicopter rotor, and offset from each other by 90 degrees. Circuitry for generating the I and Q signals is described below. Each of these signals is provided to a respective variable-gain amplifier 48, 50 whose outputs are provided to the summer 28 as the cancellation drive signal 27. The gain for each of the amplifiers 48, 50 is continuously generated by respective gain-adjustment circuitry including multipliers 52, 54 and integrators 56, 58 as shown, along with outputs from a phase function 60 (labeled H(φ)).

In operation, the phase function 60 uses the error signal 31 from the bench IMU 42 to generate an estimate of large-scale phase compensation in the motor position control system, and this value is provided to the multipliers 52 and 54 along with the respective vibration reference signal I, Q. The output from each multiplier 52, 54 is provided to a respective integrator 56, 58, each of which integrates over a fairly long time constant—on the order of 10-20 seconds for example. The integrators 56, 58 act to reduce noise and high-frequency signal components so that the gain supplied to the amplifiers 48, 50 changes smoothly and at an appropriately slow rate. This rate, which is determined by the time constant, roughly corresponds to the expected dynamic behavior of the helicopter in operation (i.e., mechanical response to changing operating conditions including change of velocity or attitude, wind or other environmental conditions, etc.) that influences the level of vibration over time.

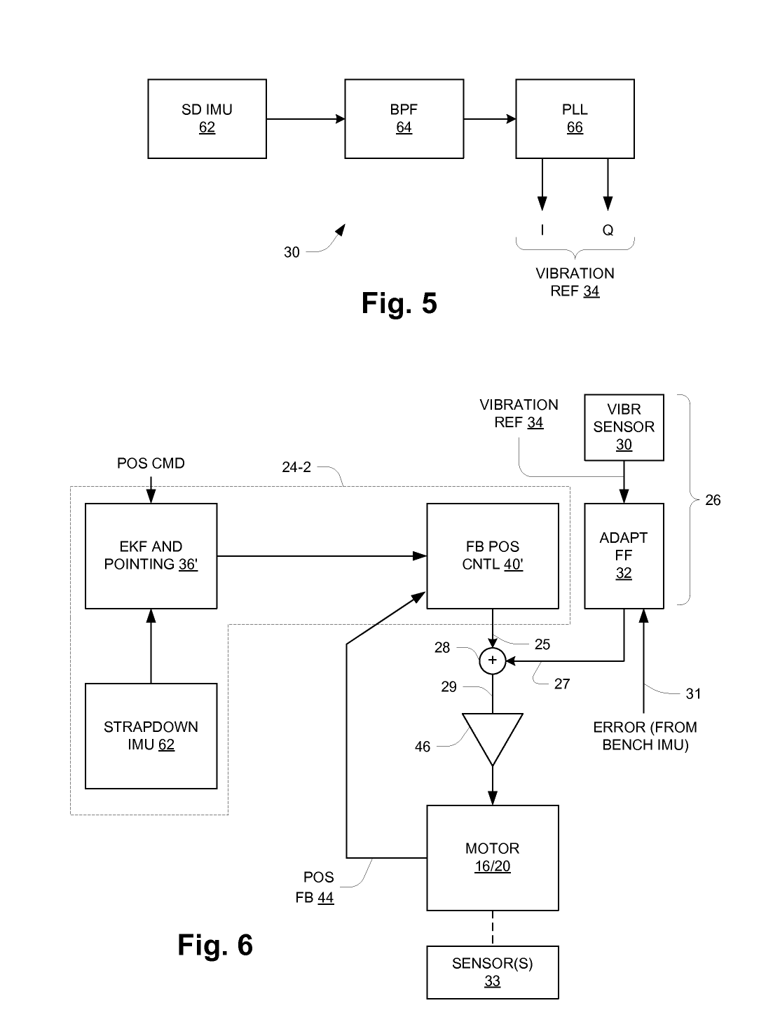

FIG. 5 shows an example of a vibration sensor 30. A “strapdown” IMU (SD IMU) 62 generates a once-per-rotation signal at the rotor rotational frequency. The strapdown IMU 62 is carried by the vehicle body/frame 12 (FIG. 1), in contrast to the bench IMU 42 which is on the gimbal-mounted optical bench 18. The once-per-rotation signal is filtered by a bandpass filter (BPF) 64 to remove noise and unwanted signal components away from the rotor frequency, and the filtered signal is provided to a phase-locked loop (PLL) 66 which generates the vibration reference signal 34. As previously indicated, in the illustrated embodiment the sub-signals I and Q are preferably sinusoidal at the rotor frequency, and offset from each other by a constant 90 degrees of phase.

FIG. 6 shows an alternative architecture for the motion control circuitry. The circuitry is similar to that of FIG. 3, while using somewhat different main position control circuitry 24-2. In the illustrated arrangement, EKF and pointing circuitry 36′ provides a commanded angle signal to the feedback position controller 40′, which itself receives the position feedback signal 44 and uses it to effect the main positioning of the motor 16/20. The main position control circuitry 24-2 uses position signals generated by the strapdown IMU 62, in contrast to the use of the bench IMU 18 in the arrangement of FIG. 3.

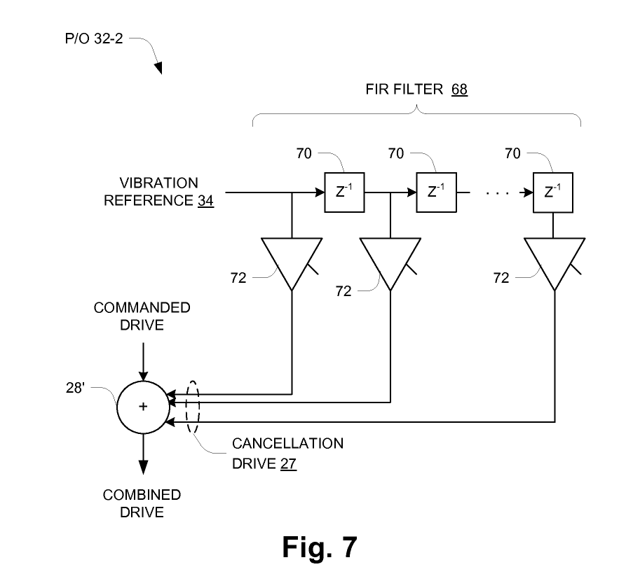

FIG. 7 illustrates part of a potential alternative realization 32-2 of the adaptive feed-forward control circuitry 32. For ease of description, components for only one of the I, Q sub-signals is shown. The vibration reference signal 34 (e.g., I or Q) is provided to a finite-impulse-response (FIR) filter 68 which includes a set of cascaded one-stage delay elements 70 (each labeled z⁻¹) and a corresponding set of variable-gain amplifiers 72, whose outputs collectively form the cancellation drive signal 27 provided to the summer 28′. This structure can provide for correction of vibration having a more broadband characteristic, whereas the structure of FIG. 4 is more tailored for correction of narrowband vibration such as that caused by a helicopter main rotor.

While various embodiments of the invention have been particularly shown and described, it will be understood by those skilled in the art that various changes in form and details may be made therein without departing from the scope of the invention as defined by the appended claims.

What is claimed is:

1. Motion control circuitry for controlling motion of a vehicle-borne, gimbal-mounted sensor positioned by a positioning element, comprising:
main position control circuitry operative to generate a commanded drive signal representing a desired driving of the positioning element to achieve a desired position of the sensor, the commanded drive signal being generated in response to a position command signal and a position feedback signal, the position command signal representing the desired position of the sensor, the position feedback signal representing a sensed actual position of the sensor;
feed-forward vibration cancellation circuitry operative to generate a cancellation drive signal representing a desired driving of the positioning element to cancel a vehicle vibration mechanically transmitted to the sensor, the feed-forward vibration cancellation circuitry including a vibration sensor and adaptive feed-forward control circuitry, the vibration sensor being responsive to the vehicle vibration to generate a vibration signal representative thereof, the adaptive feed-forward control circuitry applying a feed-forward gain to the vibration signal to generate the cancellation drive signal, the feed-forward gain being continually calculated as an integrating function of the vibration signal and an error signal which includes an estimate of a mechanical response of the positioning element to the vehicle vibration; and
combining circuitry operative to combine the commanded drive signal and cancellation drive signal to generate a combined drive signal controlling the driving of the positioning element.

2. Motion control circuitry according to claim 1, wherein:
the vehicle vibration to be cancelled has a fundamental vibration frequency variable over a small range and the vibration signal has a corresponding narrowband characteristic; and
the adaptive feed-forward control circuitry is configured to generate the feed-forward gain having substantially the same narrowband characteristic as the vibration signal.

3. Motion control circuitry according to claim 2, wherein the vibration sensor includes a phase locked loop which generates the vibration signal, the phase locked loop being configured to be phase locked to a per-rotation signal indicative of rotation of a helicopter rotor.

4. Motion control circuitry according to claim 3, wherein:
the phase locked loop is configured to generate the vibration signal to include in-phase and quadrature component signals;
the error signal includes a component representing a coarse phase compensation of sensor position; and
the adaptive feed-forward control circuitry is configured to generate the feed-forward gain to include a phase component as a function of the coarse phase compensation and in-phase and quadrature component signals.

5. Motion control circuitry according to claim 1, wherein the adaptive feed-forward control circuitry includes:
a variable-gain amplifier operative to generate the cancellation drive signal from the vibration signal and a variable feed-forward gain value;
a multiplier operative to multiply the vibration signal by the error signal to produce a product signal; and
an integrator operative to time integrate the product signal to produce the variable feed-forward gain value, the integrator having a frequency response substantially mirroring an expected dynamic behavior of the vehicle vibration in operation.

6. A vehicle, comprising:
a gimbal-mounted sensor positioned by a positioning element;
a source of vehicle vibration mechanically transmitted to the sensor; and
the motion control circuitry of claim 1 configured and operative to control motion of the sensor with cancellation of the vehicle vibration from the source.

7. A vehicle according to claim 6, including a strapdown inertial measurement unit affixed to a body of the vehicle, the strapdown inertial measurement unit including the vibration sensor.

8. A vehicle according to claim 6, wherein the vibration sensor includes a phase locked loop which generates the vibration signal.

9. A vehicle according to claim 6, wherein the sensor is an imaging sensor.

10. A vehicle according to claim 6, wherein the sensor and motion control circuitry are mounted in a turret affixed to a body of the vehicle.

11. A vehicle according to claim 6, wherein the sensor is mounted in a turret affixed to a body of the vehicle, and the motion control circuitry is located away from the turret.

12. A vehicle according to claim 6, the vehicle being a helicopter having a rotor which is the source of the vehicle vibration.

13. A vehicle according to claim 12, including a strapdown inertial measurement unit affixed to a body of the helicopter, the strapdown inertial measurement unit including the vibration sensor.

14. A vehicle according to claim 12, wherein the vibration sensor includes a phase locked loop which generates the vibration signal, the phase locked loop being phase-locked to a per-rotation signal indicative of rotation of the rotor.

15. A vehicle according to claim 12, wherein the sensor is an imaging sensor.

16. A vehicle according to claim 12, wherein the sensor and motion control circuitry are mounted in a turret affixed to a body of the helicopter.

17. A vehicle according to claim 12, wherein the sensor is mounted in a turret affixed to a body of the helicopter, and the motion control circuitry is located away from the turret.

18. A method of controlling motion of a vehicle-borne, gimbal-mounted sensor positioned by a positioning element, comprising:
generating a commanded drive signal representing a desired driving of the positioning element to achieve a desired position of the sensor, the commanded drive signal being generated in response to a position command signal and a position feedback signal, the position command signal representing the desired position of the sensor, the position feedback signal representing a sensed actual position of the sensor;
generating a cancellation drive signal representing a desired driving of the positioning element to cancel a vehicle vibration mechanically transmitted to the sensor, the generating including (a) generating a vibration signal representative of the vehicle vibration, and (b) applying an adaptive feed-forward gain to the vibration signal to generate the cancellation drive signal, the feed-forward gain being continually calculated as an integrating function of the vibration signal and an error signal which includes an estimate of a mechanical response of the positioning element to the vehicle vibration; and
combining the commanded drive signal and cancellation drive signal to generate a combined drive signal controlling the driving of the positioning element.

19. A method according to claim 18, wherein the vehicle vibration to be cancelled has a fundamental vibration frequency variable over a small range and the vibration signal has a corresponding narrowband characteristic, and the feed-forward gain is generated so as to have substantially the same narrowband characteristic as the vibration signal.

20. A method according to claim 19, wherein generating the vibration signal includes operating a phase locked loop configured to be phase locked to a per-rotation signal indicative of rotation of a helicopter rotor.

21. A method according to claim 20, wherein:
the phase locked loop is configured to generate the vibration signal to include in-phase and quadrature component signals;
the error signal includes a component representing a coarse phase compensation of sensor position; and
the feed-forward gain is generated to include a phase component as a function of the coarse phase compensation and in-phase and quadrature component signals.

22. A method according to claim 18, wherein generating the cancellation drive signal includes applying a variable feed-forward gain value to the vibration signal, and further including:
multiplying the vibration signal by the error signal to produce a product signal; and
time-integrating the product signal to produce the variable feed-forward gain value, the time-integrating having a frequency response substantially mirroring an expected dynamic behavior of the vehicle vibration in operation.
